(19) United States
(12) Patent Application Publication
(10) Pub. No.: US 2009/0058850 A1
(43) Pub. Date: Mar. 5, 2009

(54) System and method for intuitive interactive navigational control in virtual environments

(76) Inventor: Wey Fun, Singapore (SG)

Correspondence Address: Wey Fun, BLK.512, #10-508, Bukit Batok st.52, Singapore, 650512, SG

(21) Appl. No.: 11/897,902

(22) Filed: Sep. 4, 2007

(51) Int. Cl. G06T 15/00

(52) U.S. Cl. 345/419

(57) ABSTRACT

A human-computer-interface design scheme makes possible the creation of an interactive intuitive user navigation system that allows user to issue his intended direction and speed for traversing in the virtual environment with just appropriately positioning a tracker within the operating space. The interface system contains the information about the boundary and center of an arbitrarily-defined static zone within the operating space of the tracker. If the tracker is positioned inside this static zone, the system would interpret it as no traverse is intended. When the user decides to move in a particular direction, he just needs to move the tracker outside the static zone in that direction, and the computer would be able to calculate the intended traverse vector by finding the vector from the center of the static zone to the position of the tracker. The further the tracker is positioned from the static zone, the greater the speed of the intended traverse.

### REFERENCE CITED

U.S. Patent Documents

| | | | |
|---|---|---|---|
| Application no. 20060082546 | April 2006 | Fun | 345/156 |
| 6,135,928 | October 2000 | Butterfield | 482/69 |
| 6,646,643 | November 2003 | Templeman | 345/473 |
| 7,058,896 | June 2006 | Hughes | 715/757 |
| 7,101,318 | September 2006 | Holmes | 482/54 |
| 7,184,037 | February 2007 | Gallery et al | 345/419 |

### FIELD OF INVENTION

The present invention is generally related to navigation in computer-simulated environments. More specifically it is related to user interfaces for navigating in computer-simulated three-dimensional (3D) environment.

### BACKGROUND OF THE INVENTION

Great advances have been made in computer-simulated 3D environments, particularly the creation and simulation of real-time user-interactive virtual reality (VR) environments. Recently there are significant advances in the development and utilization of 3D motion-tracking and input technologies, and these created the whole plethora of new ways of realistically interacting with computer-generated environments for entertainment, training or CADCAM purposes. In typical 3D virtual reality applications, there are two requirements for real-time user's interaction with the virtual environment. One of them is the mean to let the human user manipulate or move virtual objects in the virtual world, and the other is the mean to let user navigates in the virtual world. The former involves either changing the pose or shape of the virtual objects but does not involve changing the user's represented position in the virtual world. The latter involves navigation where the user's represented position in the virtual world would be changed, as if the user is traversing in the virtual world, and this would result in change of perspective viewpoint, and hence change of displayed view, in the simulation.

The former requirement could usually be fulfilled with a handheld tracking device (hereinafter refer to as the “tracker”) that could provide its 3D pose in the real world in real-time to the computer. It could be based on various 3D motion-tracking technologies such as optical tracking, magnetic tracking, ultrasound tracking and gyros-cum-accelerometer-based tracking. The corresponding virtual object (hereinafter refer to as the “effector”) would be “slaved” to the manipulation tracker, and the user would then be able to change the pose of this effector by physically pose the tracker accordingly. An example of this tracking method is described in U.S. patent application no. 20060082546.

For the latter requirement on navigation, the underlying task is to allow user to move freely over large span of space in the virtual world, while actually remain within a relatively small confined space or even stationary in the real world. For simple desktop gaming and applications, a common method adopted is the use of joystick or directional keys on gamepad for the user to convey the intended navigation to the computer by just manually moving the joystick or pushing the buttons accordingly. This is feasible provided that the application involves little interference between manipulative and navigational tasks, such that both can be fulfilled by hand controls.

With the increasing use of more affordable 3D input products, particularly those capable of full 6-DOF tracking, the fidelity and complexity of VR manipulation tasks are being increased. This leads to demand for more share of the limited cognitive processing power of the user. This eventually evolves to a phase where hand control is saturated by the manipulation task, and the user faces difficulties using hands simultaneously for both manipulative and navigational controls.

This can be observed from the problems in the attempts made to use joystick/keypad method for VR simulations involving the use of 3D manipulation-tracking devices. The straightforward adapted method would be to embed conventional joystick or keys onto the handheld tracker. An example is that of Nintendo's Wiimote controller with the accompanying Nanchuck controller, which have a joystick and directional push buttons embedded in them. The main problem is disorientation: since the tracker is to be posed according to the manipulation requirement, it is usually pointing towards a direction that is not in-line with the desired direction of traverse. In this case the user would find it hard to relate the direction of the push buttons or joystick embedded within the tracker to the desired direction of movement

Another problem is that the joystick or push buttons are suitable for 2D navigation only, and not efficient for conveying 3D movement. Furthermore the user may find it awkward manipulating the tracker with one hand, and using the other hand to operate on the joystick or push buttons on the tracker while it is being moved. This is particularly so if the tracker is being moved quickly. To help visualizing the problem, just imagine the tracker is being used in a sword-fighting game—while the user swings the tracker in controlling the virtual sword to fight the virtual opponent, he would have problem simultaneously pressing the navigation buttons embedded on the device to control his traverse in accordingly positioning his avatar in the virtual world. The underlying problem is that for more sophisticated applications where complex manipulations and navigations are involved, there would be too much interference between the manipulative and navigational controls if both are being carried out via handheld controllers. The human’ neural system is not built to issue command signals to one hand for doing one thing, while simultaneously issue command signals to another hand for doing something entirely different.

Another method, especially suitable for full-body VR applications, is to use foot-activated buttons that are laid on the floor, and the user could indicate his intended direction of traverse in the virtual world by stepping on the corresponding button laid closest to that direction. A common gadget belonging to this category is the dance pad used in dancing games. However this method only gives very approximate navigational control as only a limited number of discrete buttons can be laid around the operating space, hence limiting the resolution of the control. Furthermore it is limited to only 2D planar navigation. It also does not allow the user to efficiently variably specify the speed of traverse.

There are also inventions about the conjunctive use of omni-directional treadmills, which are mechanical equipment for capturing 2D locomotion, for navigational controls in VR applications. Some examples of this equipment are described in U.S. Pat. Nos. 7,101,318 and 6,135,928. However these treadmills are very costly to acquire, operate and maintain. Furthermore they are restricted to only 2D locomotion. They usually require some forms of harness to prevent the user from falling as running on them can be unstable. This restrains the user from doing fast-turning and rapid change of gait patterns.

In U.S. Pat. No. 6,646,643, there is mention of a method and apparatus for 3D locomotive input. However this invention uses many sensors mounted on the knees and feet of the user to compute his gait pattern. Not only does it require lengthy calibration to each user's legs' dimensions, it also suffers from cumulative errors from so many the sensors. Even if it works, it would still require the use of omni-directional treadmill to solve the problem with limited operating space.

In U.S. Pat. No. 7,184,037, a navigational aid in the form of a virtual environmental browser is mentioned. However the navigation requirement mentioned is relatively too simplistic and can be fulfilled with very few control buttons housed in a control stick. Furthermore there is no mention of how the invention could be integrated with manipulation tasks. Such invention is thus not applicable for realistic navigational control.

In U.S. Pat. No. 7,058,896, there is mention of the method, system and product for creating HCl schemes for intuitive navigational controls using customized physics-based assemblies. It is more for creating visually-pleasant cinematic sequences in VR simulations. There is no mention of how this invention could be used with 3D trackers and how it could be integrated with complex manipulation controls.

In view of the abovementioned problems associated with existing methods, the present invention is to provide a better solution for navigational control that is cost-effective, intuitive and realizable with existing technology.

### BRIEF SUMMARY OF THE INVENTION

The present invention provides a system and method for creating an interactive intuitive user navigation control for navigating in a real-time three-dimensional virtual environment generated by a computer. This is a human-computer-interface design scheme that allows user to convey to the computer his intended direction and speed for traverse in the virtual environment with just appropriately positioning a tracker within the operating space, without the need for joystick or pushbutton controls embedded in the tracker. The tracking system contains the parameters defining an operating space in the real world within which the tracker's position can be input to the computer. Within this operating space, a contiguous static zone is prescribed. This static zone is defined by an arbitrary center and the boundary. When the tracker's position, as defined by a point relative to the whole topology of the tracker, falls within this static zone, the system would interpret it as no traverse is intended. When the user decides to move in a particular direction, he just needs to move the tracker beyond the static zone in that direction, and the computer would be able to calculate the intended traverse vector from the bearing vector which is obtained by subtracting the position of the tracker from the arbitrary center of the static zone. The further the tracker from the boundary of the static zone, the greater the speed of the intended traverse.

The simplest implementation would be to use a single tracker for both manipulative and navigational tasks. This would be most appropriate for the set of applications where the user could combine both manipulative and navigational tasks with minimal interference between the two. A subset of these applications is those where the manipulative direction is almost collinear with the direction of traverse. An example is that of a VR tennis game. When the user wants to stretch and catch a returning ball at a distance, he would most likely point the tennis racket towards that direction of intercept, which is also the intended direction of traverse. Another subset of these applications is those where the manipulation is relatively not wild-moving. An example is shooting game, where the user holds the gun with relative small span of movement. He could point the gun tracker in the direction of the target while moving side-ward in another very different direction. This could also be applied for some desktop games where the user does not use his legs to issue navigational commands, and that the navigational commands have to be issued using miniature handheld tracker.

For applications involving wide-span manipulative actions while requiring precise navigational controls, or when the manipulation and navigation tasks are too exclusive, a handheld manipulation tracker and a separate navigation tracker would be required to be simultaneously used by the user. This navigation tracker is placed or worn in a position on the user's body that is stable relative to the reference frame of the user. This tracker would be dedicated to providing the real-world's position of the user to the computer, which is then used for determining the traverse vector in the virtual world.

This present invention has numerous advantages over the previous methods. Firstly it is intuitive—the user can just move the tracker outside of the static zone in the direction of intended traverse to issue the command for movement. When he wants to stop the traverse he just needs to move the tracker back inside the static zone. All he needs to be aware of is the approximate center and boundary of the static zone, which can be marked on the operating floor or displayed in the simulation. The user could also have feedback correction of the navigational control by observing the result of the computer-generated traverse relative to his legged movement.

Secondly there is no need for additional navigational push buttons or joystick on the handheld tracker, and thus no problem with disorientation. This is particularly essential for some critical training systems where the controls are to be as closely modeled as the real thing. The user would also be able to use both his hands for the manipulative controls, while using his legged movement for navigational controls. This is more intuitive than previous methods where navigational commands are issued with hand/finger movement. It is more neurologically sound as human's neural system has separate but coordinated pathways for the two tasks.

Thirdly the issued navigational commands are continuous and analog in nature, and thus can more accurately reflect the user's intended direction of traverse than using the few discrete switches in the dancepad. The speed of traverse can also be variably controlled with the distance of tracker away from the static zone's boundary.

Fourthly, there is no need for complex mechanical equipment such as omni-directional treadmill for traversing, which saves a lot of costs and troubles.

Additional features and advantages of the invention will be set forth in the description that follows, and in part will be apparent from the description, or may be learned by practice of the invention. The objectives and other advantages of the invention will be realized and attained by the system and method particularly pointed out in the written description and claims hereof as well as the appended drawings.

### BRIEF DESCRIPTION OF THE DRAWINGS/FIGURES

The invention will now be described, by way of example only, with reference to the accompanying drawings, in which:

FIG. 1 shows an embodiment of the present invention in a 3D VR gun-shooting game simulation involving navigating in 3D space (x, y and z directions), as in astronauts shooting at each other in outer space, or divers shooting at each other in the sea;

FIG. 2 shows how the user, when he decides to issue a navigational command, moves the tracker outside the static zone. The bearing vector from the center of the static zone to the position of the tracker would then be used to generate the traverse vector in the simulation;

FIG. 3 shows a more down-to-the-earth VR simulation, where navigation is carried out in 2D terrains. The static zone in this case is a planar 2D segment scribed on the floor;

FIG. 4 shows an embodiment of sword-action game where the user wears a navigation tracker as part of his head gear, while holding a manipulative tracker in the shape of a sword and fighting against a virtual opponent. It is to illustrate how the use of two trackers can be accommodated by the present invention to achieve enhanced simulation.

### DETAILED DESCRIPTION OF THE INVENTION

A detailed description of the present invention will now be given in accordance with a few alternative embodiments of the invention. In the following description, details are provided to describe the preferred embodiment. It shall be apparent to one skilled in the art, however, that the invention may be practiced without such details. Some of these details may not be described at length so as not to obscure the invention.

The following are abbreviated terms used in the document:

VR—virtual reality
3D—three-dimensional
DOF—degree-of-freedom

### HCl—Human-Computer Interface

The term “computer” includes, but is not limited to, any computing device or cluster of computing devices that could generate and/or render 3D models such as CAD/CAM workstations, “personal computers”, dedicated computer gaming consoles and devices, graphics-rendering machines and personal digital assistants.

The term “pose” of an object refers to the 6-DOF (three translational DOFs and three rotational DOFs) of the object. The term “position” refers to the three translational DOFs of the object.

It is an objective of the present invention to provide a system and method for creating an interactive intuitive user navigation system for navigating in a real-time three-dimensional virtual environment generated by a computer.

The term “real-world” state of an object refers to its physical state in real world, whereas the term “virtual” state of an object refers to the represented state of its avatar in virtual world. The term “state” in the above statement could be the “position”, “pose”, “velocity”, “shape” or other physical properties such as mass and density. The term “object” refers to either the human user or the tracker. The represented image of the object is called the “avatar”. The avatar of manipulation tracker is specifically termed “effector”.

In a typical virtual reality (VR) simulation, one or more computers are used to generate the 3D graphics, as determined by a chosen perspective view point, of a virtual environment stored in its database. The graphics is then presented to the user who would then make decision as what to do in the virtual environment. He would then input the required actions via input devices to the computer, which would then change the representing database of the virtual environment accordingly.

A main computational task is matching the user's real-world state to the represented state of his avatar in the virtual world, such that the controlling computer can generate the corresponding changes in the virtual world as intended by the user. There are two main tasks in VR interaction—manipulation and navigation. Manipulation involves changing the state of virtual objects in the virtual world through the user's manipulation in the real world. Navigation involves the user's avatar traversing across space or terrain in the virtual world through the user's conveying his intended movement. In either case, some forms of tracking the user's actions are used for communicating his intended changes in the virtual world to the computer.

A significant challenge to VR navigation task is that the user has to operate in limited space in the real world (say inside a room) while navigating over a large span of virtual space in the computer-generated virtual world. Such constraint thus requires some suitable human-computer-interface (HCl) tools and design that would allow the user to convey his intended navigation to the computer in a space-saving, and yet intuitive and simple manner. The interface design must avoid pitfalls such as mental rotation, observable lags, nonlinearity, etc. It should allow the user to quickly specify the speed and direction of intended movement with high resolution and proportionality.

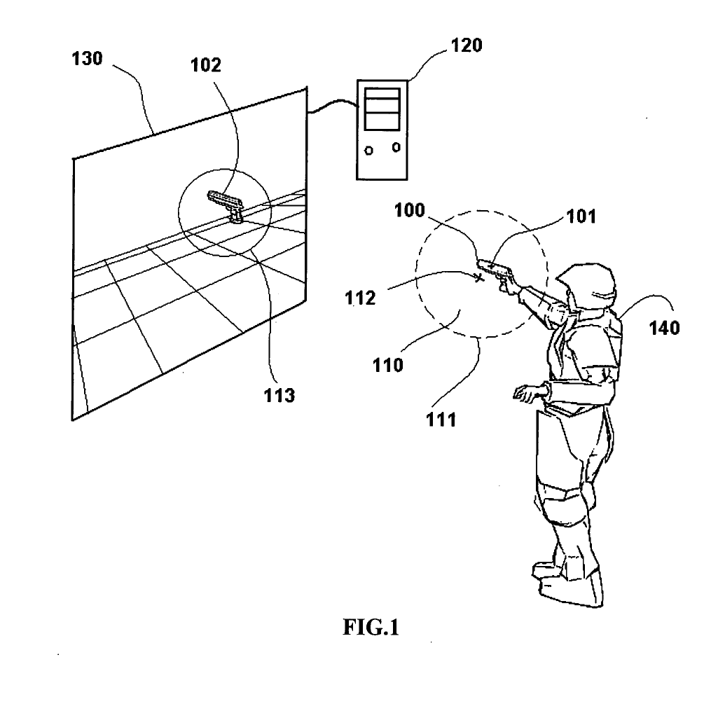

FIG. 1 shows an embodiment of the present invention in a 3D VR gun-shooting game simulation involving navigating in 3D space (x, y and z directions), as in astronauts shooting at each other in outer space, or divers shooting at each other in the sea. Typically a computer 120 will be used to generate the 3D VR environment, and this would be displayed in various means, such as a forward-facing display monitor 130, or a set of all-surround display panels, or display dome, or VR goggle, to the user 140. The computer 120 would also be continuously monitoring the user's input so that it can make corresponding changes to the simulation. In this case the navigation tracker 100, in the shape of a handgun, is hand-held by the user on his left hand. This tracker 100 could be solely dedicated to navigational purpose, or, in some applications, could also be simultaneously used for manipulative task. The effector in this case 102 is a virtual handgun as displayed. Within the operating space of the tracker 100, a static zone 110, as defined by its boundary 111 and center 112, is scribed out. The parameters defining the boundary 111 and center 112 are stored in the computer 120. This static zone 110 can be either a 2D segment or a 3D volume, and arbitrarily defined according to some criteria such as nominal span of movement, ease of positioning, and safely distant from obstacles around, etc. In this illustration it is a sphere. Its corresponding virtual image 113 could be displayed, if required, as a semi-transparent object in the display device 130. This display would allow the user 140 to better judge the position of the tracker 100 relative to the topology of the static zone 110. The tracker's real-world position is represented by an arbitrarily-defined reference point 101. Note that this point 101 may not be physically located on the tracker 100, and could be outside of it. The main criterion is that it must move along with the tracker 100 as if it is an integral part of the tracker 100. A reasonable choice would be the geometric center of the tracker 100. As long as this point 101 is positioned within the arbitrary static zone 110, the computer 120 would interpret it as no traverse is intended, and the viewpoint would not be changed. In such case the effector 102 would be moved around in the virtual environment according to how the tracker 100 is being moved within the static zone 110.

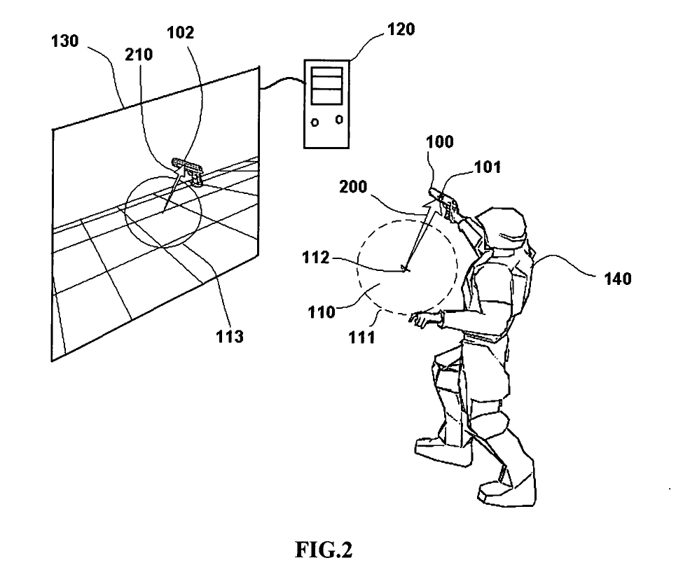

When the user 140 decides to move in a particular 3D direction, he just need to move the navigation tracker 100 in the corresponding direction beyond the boundary 111 of the static zone 110, as illustrated in FIG. 2. When the tracker's position 101 is detected by the computer 120 to be outside of the static zone 110, the event would be interpreted as navigation is intended. The computer 120 would then calculate the bearing vector 200 from the static zone's center 112 to the tracker's position 101. This bearing vector 200 would then be used as the direction of traverse 210 in the virtual environment. The direction of traverse 210 might be displayed as a 3D vector so that the user 140 has a better picture of the correspondence, which he could use as feedback to further correct or refine his navigational control. The computer 120 would further determine the speed of the traverse as a monotonically-increasing function of the distance of the tracker's position 101 beyond the boundary 111. Many formulae can be used for this monotonically-increasing function. A simple formula would be:

S=|v|*(Sₘₐₓ−S_{threshold})*c+S_{threshold};

Where S is the speed of traverse, Sₘₐₓ and S_{threshold} are respectively the maximum and threshold traverse speeds, c is a constant scalar, and |v| is the distance of the tracker's position 101 beyond the boundary 111.

The perspective view point, which determines the view displayed, will be updated in the direction of the traverse accordingly and the represented position of effector 102 will be brought along, as if the avatar is moving in the virtual world along the direction of the bearing vector 210. When the user 140 decides to stop traversing in the virtual world, he just needs to move the tracker 100 back into the static zone 110.

Note that the user 140 can continue pointing the gun tracker 100 in the same direction while moving it beyond the static zone 110. This allows him to continue shooting targets displayed in the monitor 130 while moving side-ward.

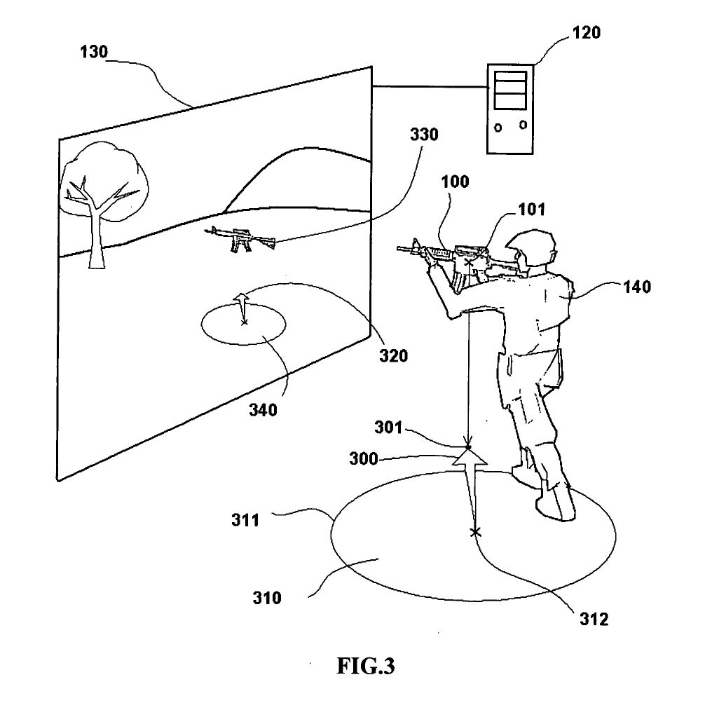

For most down-to-the-earth VR simulations, navigation is usually carried out in almost-2D terrains—e.g. running across a floor. In such cases, a modified version of the HCl design is required. As depicted in FIG. 3, it is almost identical hardware setup as in FIG. 1 except that the static zone 310 is a 2D circle arbitrarily scribed out on the floor where the user 140 is standing. The static zone 310 is defined by the center 312 and the circumference 311. The virtual zone 340 corresponding to this static zone 310 can be shown in the display device 130 to the user 140, so that he can observe the relative position of the effector 330 and the virtual zone 340. The virtual zone 340 can be displayed as a semi-transparent disc so that the faint trace would not obstruct the background. The computer 120 would find the projected position 301 of the gun tracker 100 by vertically downward-projecting the point 101 onto the 2D static zone 310. When the tracker's projected position 301 is detected to be outside of the static zone 310, the event would be interpreted as navigation is intended. The computer 120 would then calculate the bearing vector 300 from the static zone's center 312 to the tracker's projected position 301. This bearing vector 300 would then be used as the direction of traverse 320 in the virtual environment. It might be displayed as an image of a vector 320 so that the user 140 has a better picture of the correspondence, which he could use as feedback to further correct or refine his navigational control. The computer 120 would further determine the speed of the traverse as a monotonically-increasing function of the distance of the tracker's projected position 301 beyond the circumference 311 of the static zone 310.

The tracker 100 described in FIG. 3 might not need to provide all the three translational DOFs. It could just provide the two translational DOFs relevant to the planar movement along the plane where the user 140 traverses.

Note that the present invention works with applications of all sizes and need not be constrained to those involving legged movement. It could be used in a miniaturized desktop application where size of the tracker is about that of a pen or smaller.

Also note that even when the tracker 100 is positioned outside of the static zone 310, which elicits a traverse command and the viewpoint is being changed, the tracker 100 might still be used for manipulative task. For example, in a VR tennis game, while rushing towards the returning ball to intercept it, the user could also swing the tracker (while it is still positioned outside the static zone) in control of the virtual racket in an attempt to hit the ball. This is somewhat analogous to “diving to save a ball”. There is no need to return the tracker back into static zone prior to using it for manipulation task.

In the embodiments described above, the use of only one tracker 100 is described and it is for both the manipulative and navigational tasks. This is tolerable for some applications such as gun-shooting games because the involved manipulative task requires much less than six degrees-of-freedom (DOFS) of the tracker 100—i.e. determining the line-of-sight of the gun's barrel, which is all required for determining the line-of-hit of the virtual bullets. The remaining DOFs are redundant and thus can be used for navigational task. The simulation is also gun-centric—i.e. with knowledge of the position of the gun tracker 100 at anytime, and with the prior information on whether the user 140 is left- or right-handed, the computer 120 could estimate the user's pose and thus can roughly estimate his position in the virtual world. This is sufficient for estimating whether he would have been hit by virtual opponents, or bounced into obstacles in the virtual world, etc. Both manipulative and navigational tasks can thus be quite sufficiently fulfilled with the 6-DOF tracking of the gun tracker 100 alone.

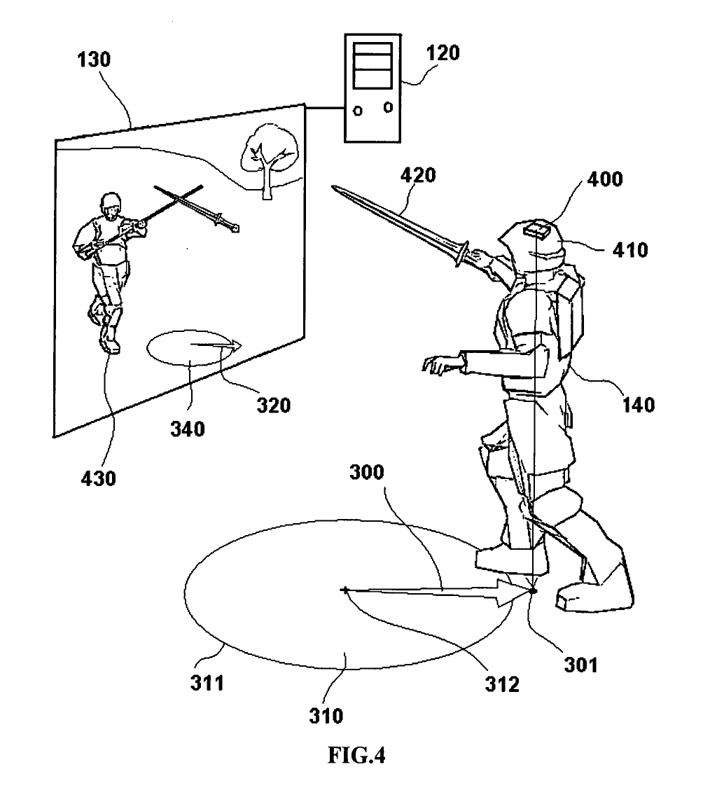

For some other applications such as sword-action games, more of the DOFs are required for the manipulative task and it would be too much interference between the two tasks if only one tracker is used. Yet in other applications there might be a need for more accurate tracking for the two tasks separately. In these cases the simultaneous use of a manipulation tracker and a navigation tracker will be required. This can be illustrated in an embodiment of sword-action game as shown in FIG. 4, where the user 140 wears a navigation tracker 400 as part of his head gear 410, while holding a manipulative tracker 420 in the shape of a sword and fighting against a virtual opponent 430. The navigation tracker 400 provides the user's head's pose to the computer 120, and serves the same function of the navigation tracker 100 as described in FIGS. 1 to 3 above. An advantage of this configuration is that the 6-DOF head's pose information can be used as perspective viewpoint by the computer 120 to generate graphics. This is particularly useful if the display device is a VR goggle.

Alternatively the navigation tracker could be worn on the trunk such that tracked position of the user's trunk could be used as the navigational input for calculating the bearing vector. This is particularly applicable if all-surround dome display configuration is used. In such case the navigation tracker needs to provide only the two or three translational DOFs, though providing the rotational DOFs are acceptable.

### CONCLUSION

Besides the numerous advantages mentioned in prior section, an additional advantage is that the bearing of navigation could be set independent of the orientation of the user and/or the orientation of the manipulation. He could be facing in one direction, pointing the manipulative tracker in another direction while traversing in yet another very different direction in the virtual environment. This advantage manifested in a shooting game would mean that the shooter could shoot in one direction while looking at another direction, and ‘running’ or striating in yet another very distinct direction, and this could be carried out simultaneously with ease as different faculties of cognition are used.

While various embodiments of the present invention have been described above, it should be understood that they have been presented by way of example only, and not limitation. It will be understood by those skilled in the art that various changes in form and details may be made therein without departing from the spirit and scope of the invention as defined in appended claims. Accordingly, the breadth and scope of the present invention should not be limited by any of the above-described exemplary embodiments, but should be defined only in accordance with the following claims and their equivalents.

1. A method for providing interactive user navigation in a real-time three dimensional simulation, comprising:
Specifying a reference point pinned relative to a navigation tracker as representative of said tracker's position in the real world;
specifying a static zone within the operating space of said navigation tracker;
specifying the center and boundary of said static zone; and
determining the direction and magnitude of the user's traverse in said simulation using the bearing vector from the center of said static zone to said navigation tracker's position when said tracker is positioned outside the boundary of said static zone.

2. A system for providing interactive user navigation in a real-time three dimensional simulation, comprising:
a navigation tracker providing its pose in the real physical world;
a database that stores the set of parameters defining the boundary and center of a static zone within the operating space of said navigation tracker; and
An algorithm for calculating direction and magnitude of the user's traverse in said real-time three-dimensional simulation using the bearing vector from the center of said static zone to said navigation tracker's position when said navigation tracker's position is outside the boundary of said static zone.

3. The system of claim 2, further comprising at least one display device.

4. The system of claim 3, wherein the representative avatar of said tracker is displayed in said display device.

5. The system of claim 3, wherein the representative avatar of said static zone is displayed in said display device.

6. The system of claim 2, wherein said static zone is a 3D sphere.

7. The system of claim 2, further comprising an algorithm to real-time compute the user's perspective view point in said simulation as changed by said bearing vector.

8. The system of claim 2, further comprising at least one manipulation tracker.

9. The system of claim 8, wherein said navigation tracker provides the user's head's pose.

10. The system of claim 8, wherein said navigation tracker provides the user's trunk's pose.

11. The system of claim 2, wherein:
said static zone is a two-dimensional planar static zone lying on a 2D plane within the operating space of said navigation tracker;
further comprising a step to calculate said navigation tracker's projected position on said two-dimensional planar static zone; and
said algorithm calculates the direction and magnitude of the user's traverse in said simulation using the bearing vector from the center of said static zone to said navigation tracker's projected position when said navigation tracker's projected position is outside the boundary of said two-dimensional planar static zone.

12. The system of claim 11, wherein said two-dimensional planar static zone is a circle.

13. The system of claim 11, wherein said 2D plane is the floor where the user stands on.

14. The system of claim 11, wherein said navigation tracker provides only two translational degrees-of-freedom along the directions of the two dimensions of said two-dimensional planar static zone.

15. The system of claim 11, wherein said navigation tracker provides three translational degrees-of-freedom.

16. The system of claim 11, further comprising at least one display device.

17. The system of claim 16, wherein the representative avatar of said tracker and said static zone are displayed in the said display device.

18. The system of claim 11, further comprising at least one manipulation tracker.

19. The system of claim 18, wherein said navigation tracker provides the user's head's pose.

20. The system of claim 18, wherein said navigation tracker provides the user's trunk's pose.
